(19) United States
(12) Patent Application Publication
(10) Pub. No.: US 2015/0347098 A1
(43) Pub. Date: Dec. 3, 2015

(54) EXTENDING A DEVELOPMENT ENVIRONMENT WITH ADD-INS

(71) Applicant: Microsoft Corporation, Redmond, WA (US)

(72) Inventors: Ramakanthachary S. Gottumukkala, Sammamish, WA (US); Suriya Narayanan, Redmond, WA (US); Suresh Kumar Reddy Kotapalle, Bothell, WA (US); Nitinkumar Shah, Seattle, WA (US); Andre Filipe Pires de Carvalho D Aquino Lamego, Copenhagen (DK); Ian Beck, Sammamish, WA (US)

(21) Appl. No.: 14/505,996

(22) Filed: Oct. 3, 2014

Related U.S. Application Data
(60) Provisional application No. 62/004,450, filed on May 29, 2014.

(51) Int. Cl. G06F 9/44; G06F 9/445

(52) U.S. Cl. CPC G06F 8/38; G06F 8/60

(57) ABSTRACT

A design time extension framework provides a set of application programming interfaces that are used by a developer to create extensions to the development environment.

### CROSS-REFERENCE TO RELATED APPLICATION

The present application is based on and claims the benefit of U.S. provisional patent application Ser. No. 62/004,450, filed May 29, 2014, the content of which is hereby incorporated by reference in its entirety.

### BACKGROUND

Computer systems are currently in wide use. Development environments for developing computer systems are also in wide use.

It is not uncommon for developers to use development environments (such as interactive development environments, or IDEs) to develop computer systems. An IDE may have a plurality of different designer elements that can be used by a developer to perform the development tasks.

One example of a scenario where developers use an IDE to perform development, is in developing or modifying business systems. Business systems are often relatively large computer systems and can include, for instance, enterprise resource planning (ERP) systems, customer relations management (CRM) systems, line-of-business (LOB) systems, among a variety of others. Business systems are often developed, or manufactured, by a manufacturer who sells a base system which is often customized (and sometimes highly customized) to meet the needs of an individual organization, so that it can be deployed at that organization. Thus, developers may use an IDE to not only develop the base product, but also to perform development in customizing the base product to meet the needs of the end user organization. Such developments are sometimes performed by independent software vendors (ISVs), partners, developers or by other parties.

In performing development tasks, a developer may find that the particular set of interactive development tools provided by the IDE are insufficient, inefficient, or otherwise not adequate for the developer on a given project. For a developer to write his or her own interactive tools, the developer may spend a relatively large amount of time and other resources in generating code that may not necessarily be relevant to their development task.

The discussion above is merely provided for general background information and is not intended to be used as an aid in determining the scope of the claimed subject matter.

### SUMMARY

A design time extension framework provides a set of application programming interfaces that are used by a developer to create extensions to the development environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a development architecture.

FIG. 1A shows one example of a user interface display.

FIG. 2 is a flow diagram illustrating one embodiment of the operation of the architecture shown in FIG. 1 in facilitating the creation of extensions (or add-ins) to the development environment.

FIG. 3 is a flow diagram illustrating one embodiment of the operation of the architecture shown in FIG. 1 in which a developer uses an extension (or add-ins).

FIGS. 3A and 3B are examples of user interface displays showing add-ins accessible from a main menu and a designer.

FIGS. 4-7 illustrate class diagrams for one embodiment of a design time extension framework.

FIG. 8 shows the development architecture in a cloud computing architecture.

FIG. 9 shows a block diagram of one embodiment of a computing environment.

### DETAILED DESCRIPTION

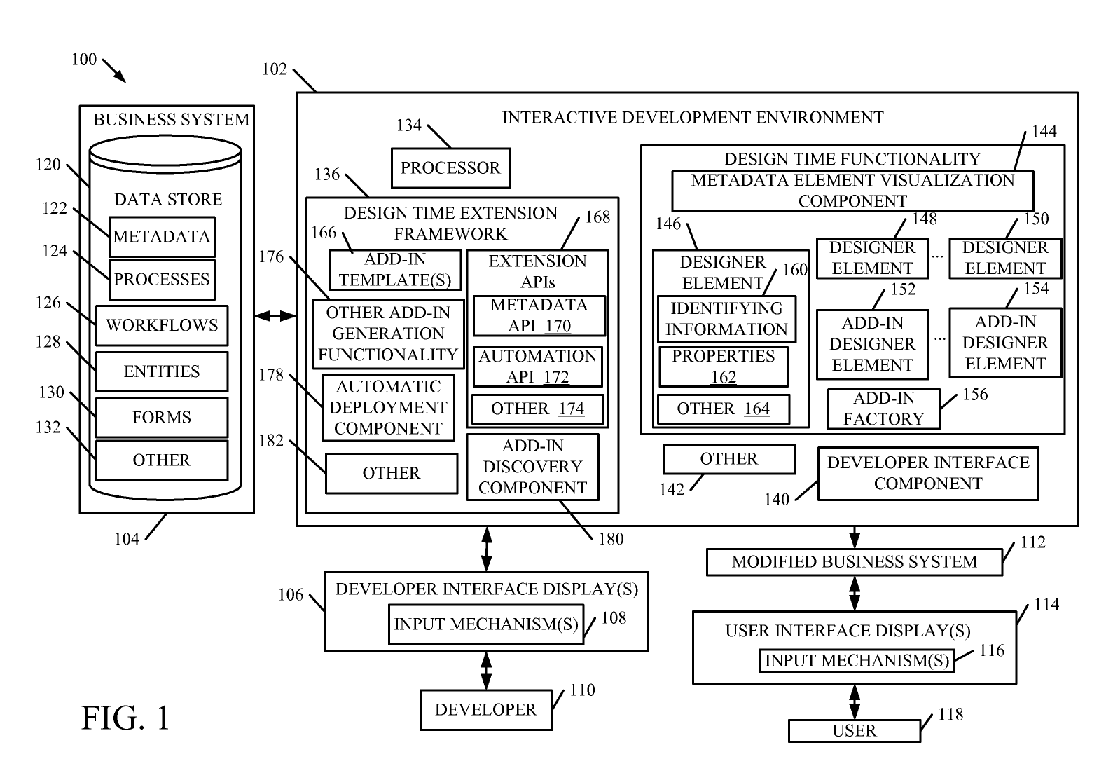

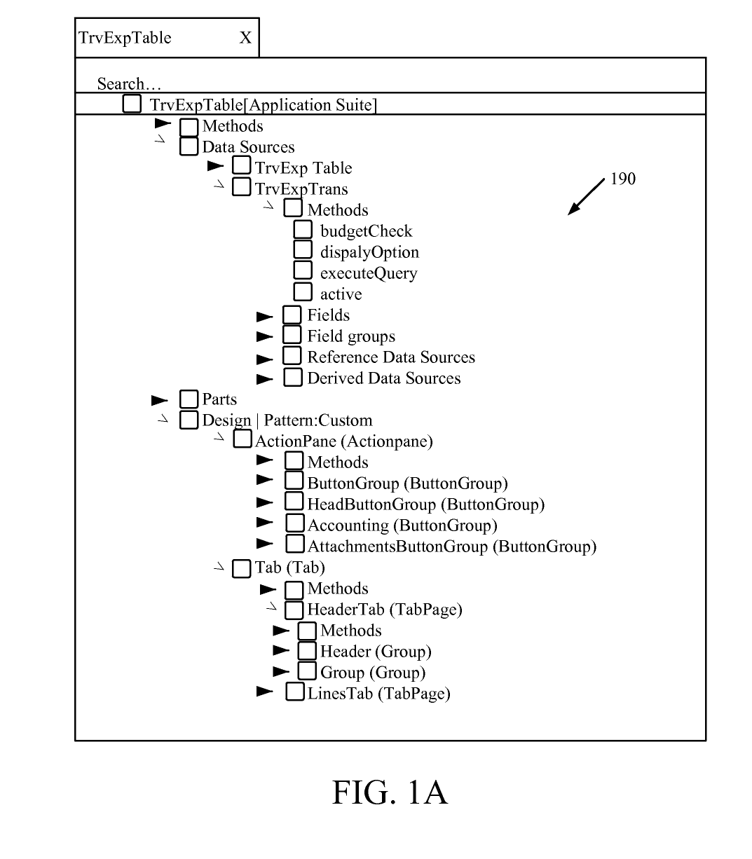

FIG. 1 is a block diagram of one embodiment of a development architecture 100. In architecture 100, an interactive development environment (IDE) 102 is shown as having access to metadata that defines various components of a business system 104. IDE 102 generates developer interface displays 106 with input mechanisms 108 for interaction by developer 110. Developer 110 interacts with input mechanisms 108 to control and manipulate IDE 102.

Developer 110 illustratively does this to develop or modify business system 104 into modified business system 112. Modified business system 112 is illustratively modified to meet the needs of a given organization that is deploying modified business system 112. Therefore, once modified, it generates user interface displays 114 with user input mechanisms 116 that are interacted with by user 118 in order to control and manipulate modified business system 112. User 118 does this in order to perform the business tasks of the organization deploying modified business system 112.

It will be noted that, while architecture 100 is shown with IDE 102 being used to modify business system 104 to generate modified business system 112, a business system is only one example of a scenario where a developer may use IDE 102. A wide variety of other scenarios can be used as well. The business system scenario is described for the sake of example only.

In the example shown in FIG. 1, business system 104 illustratively includes a data store 120 that stores metadata 122. The metadata can define processes 124, workflows 126, entities 128, forms 130, and a wide variety of other business information 132. In order to modify business system 104 to generate modified business system 112, developer 110 often modifies the metadata 122 to refine the various processes, workflows, entities, forms, etc. to meet the needs of the organization deploying modified business system 112, or to create new processes, workflows, entities, forms, etc. In doing so, a developer can make those changes using IDE 102.

In the embodiment shown in FIG. 1, IDE 102 illustratively includes processor 134, design time extension framework 136, design time functionality 138, developer interface component 140, and it can include a wide variety of other items 142 as well. Developer interface component 140, either on its own or under control of another item in IDE 102, illustratively generates the developer interface displays 106 so that developer 110 can use IDE 102.

Design time functionality 138 illustratively provides the design time functionality that developer 110 can use in order to modify business system 104. In the embodiment shown in FIG. 1, design time functionality 138 includes metadata element visualization component 144, a plurality of designer elements 146, 148 and 150, along with a plurality of add-in designer elements 152-154, an add-in factory 156, and it can include other items 158 as well. In the example shown in FIG. 1, each designer element (and each add-in designer element) includes identifying information 160, a set of properties 162 and other information 164. The properties 162 illustratively identify a particular portion of the metadata that the designer element (or add-in element) can be used to generate or modify.

FIG. 1A shows one example of a user interface display that can be generated by design time functionality 138 in IDE 102. FIG. 1A illustratively shows a hierarchical metadata structure 190 that defines a portion of business system 104. Metadata element visualization component 144 generates the visualization shown in FIG. 1A, and design time functionality 138 allows developer 110 to generate additional metadata in structure 190, or to modify the structure 190. Developer 110 illustratively does this to meet the needs of the particular organization that will be deploying the business system.

As discussed in the background section, it may be that developer 110 finds the designer elements 146, 148 and 150, that already exist in IDE 102, to be insufficient for the development task at hand, for a variety of different reasons. Therefore, in one embodiment, developer 110 illustratively uses design time extension framework 136 to generate his or her own add-in designer elements 152-154.

In the embodiment shown, framework 136 illustratively includes add-in templates 166, extension application programming interfaces (APIs) 168, which, themselves, include metadata API 170, automation API 172, and it can include other APIs 174. Framework 136 also illustratively includes other add-in generation functionality 176, automatic deployment component 178, add-in discovery component 180, and it can include other items 182 as well.

Developer 110 can illustratively author add-ins from scratch, or developer 110 can invoke add-in templates 166 which help facilitate the generation of add-ins. Metadata API 170 is illustratively a programming interface that enables creating and changing metadata elements in the file system of business system 104. Automation API 172 is illustratively a programming interface that enables creating and changing designer elements (such as creating add-in designer elements 152-154, or changing designer elements 146, 148 and 150) in IDE 102. Automatic deployment component 178 automatically deploys an add-in, once it has been created by developer 110, to design time functionality 138. Add-in discovery component 180 illustratively allows developer 110 to easily discover the various add-ins 152-154 that have been deployed to design time functionality 138.

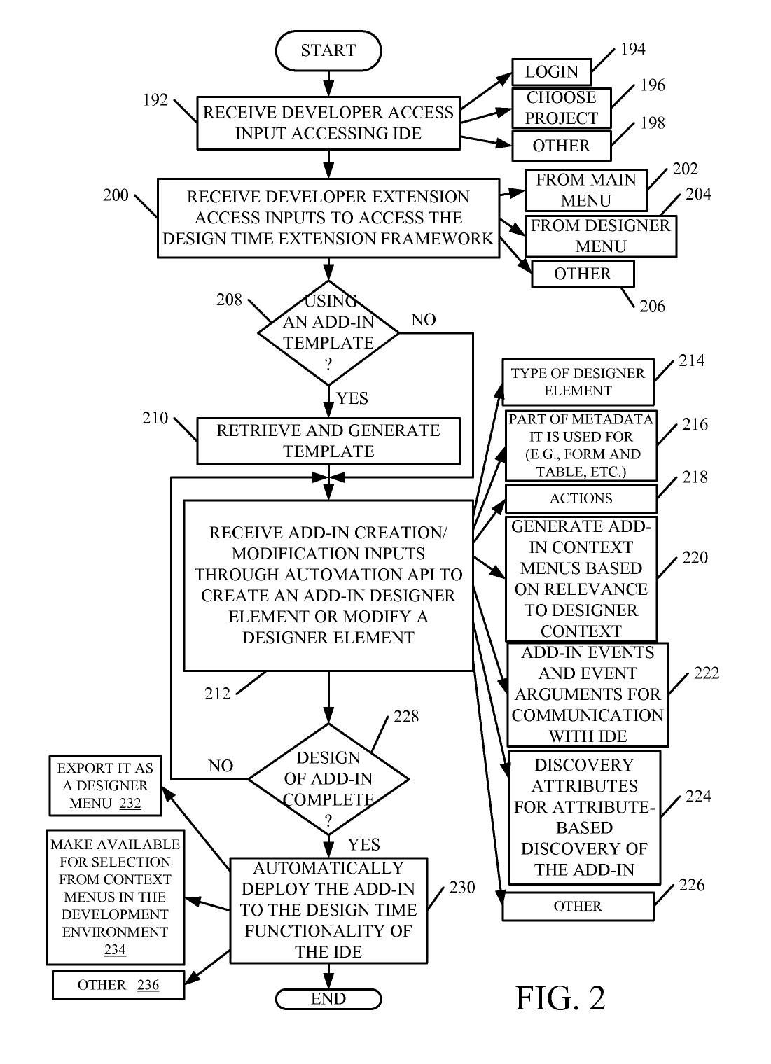

FIG. 2 is a flow diagram illustrating one embodiment of the operation of design time extension frame work 136 in allowing developer 110 to generate an add-in 152-154, as an extension to the development environment offered by IDE 102. In one embodiment, developer 110 first provides inputs accessing IDE 102. This is indicated by block 192 in FIG. 2. This can be done in a wide variety of different ways. For instance, developer 110 can provide login information 194 or developer 110 can choose a project within IDE 102. This is indicated by block 196. Developer 110 can access IDE 102 in a wide variety of other ways, as indicated by block 198.

Developer 110 then provides inputs to design time extension framework 136 indicating that the user wishes to access framework 136 to generate or modify an add-in. This is indicated by block 200 in FIG. 2. This can be done from a main menu generated from IDE 102, as indicated by block 202, it can be done from a designer menu as indicated by block 204, or it can be done in a wide variety of other ways as indicated by block 206.

IDE 102 then generates a developer interface display that allows developer 110 to indicate whether developer 110 wishes to use an add-in template 166 or to simply use add-in generation functionality 176 to generate the add-in. If the developer 110 does decide to a use a template, then framework 136 displays the template for use by developer 110. This is indicated by blocks 208 and 210 in FIG. 2.

Regardless of whether developer 110 uses an add-in template 166, developer 110 then provides inputs, such as through automation API 172, to create or modify an add-in designer element 152-154, or to modify another designer element. This is indicated by block 212 in FIG. 2. This can include a wide variety of different things. For instance, in one embodiment, developer 110 indicates the type of designer element that the add-in will be. This is indicated by block 214. Developer 110 can indicate a particular part of the metadata structure (such as a node in structure 190 shown in FIG. 1A) that the add-in will apply to. This is indicated by block 216. By way of example, developer 110 may identify a form or table, or a combination of a form and control or other items defined by the metadata structure that this particular add-in can be used for. Developer 110 illustratively provides inputs indicating the type of development actions that can be performed with the add-in. This is indicated by block 218. Add-in context menus can be generated based upon the relevance to the designer context. This is indicated by block 220. The developer 110 may also provide add-in events and event arguments that facilitate communication with the IDE during the development process. This is indicated by block 222. Developer 110 may provide metadata attributes to the add-in to facilitate attribute-based discovery of the add-in. This is indicated by block 224. Developer 110 can provide a wide variety of other information as well. This is indicated by block 226.

At some point, developer 110 will be finished designing the add-in. This is indicated by block 228. Developer 110 will then provide an input indicating this. Automatic deployment component 178 then automatically deploys the add-in to the design time functionality 138 of IDE 102. This is indicated by block 230 in FIG. 2. Deployment can also be done in a wide variety of different ways. For instance, automatic deployment component 178 can export the add-in as a designer menu, into design time functionality 138. This is indicated by block 132.

Automatic deployment component 178 illustratively makes the newly created add-in available for selection from context menus in design time functionality 138 of IDE 102. This is indicate by block 134. Automatic deployment component 178 can perform a variety of other tasks as well. This is indicated by block 236.

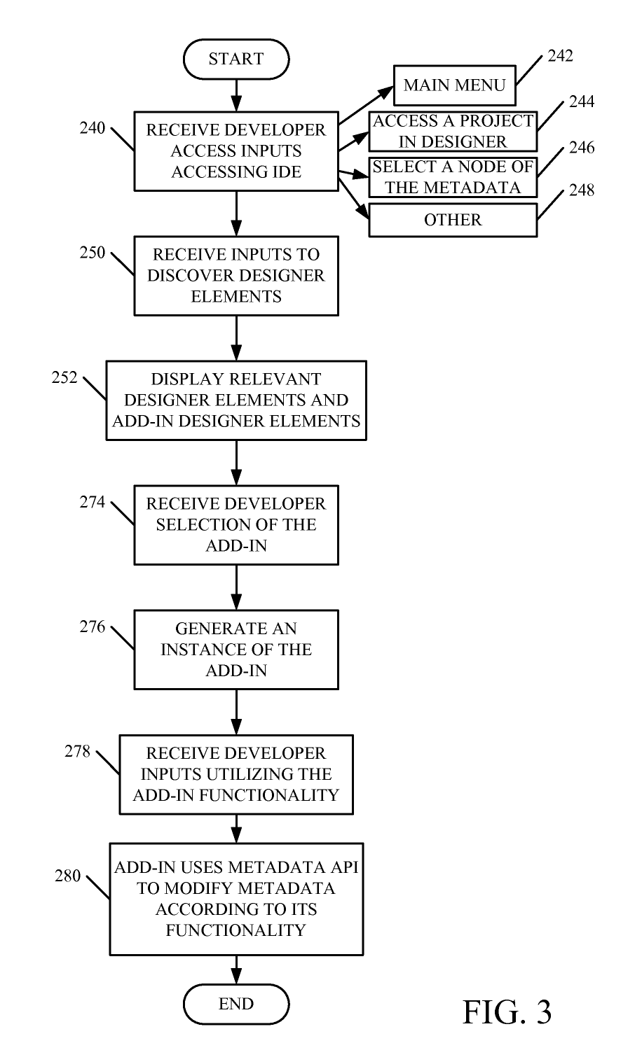

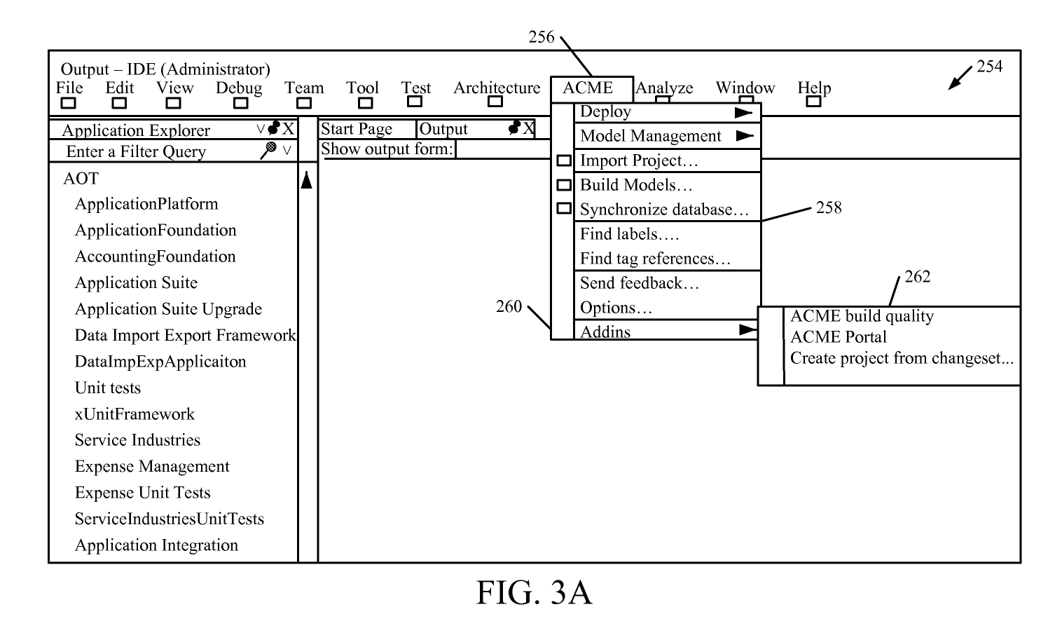

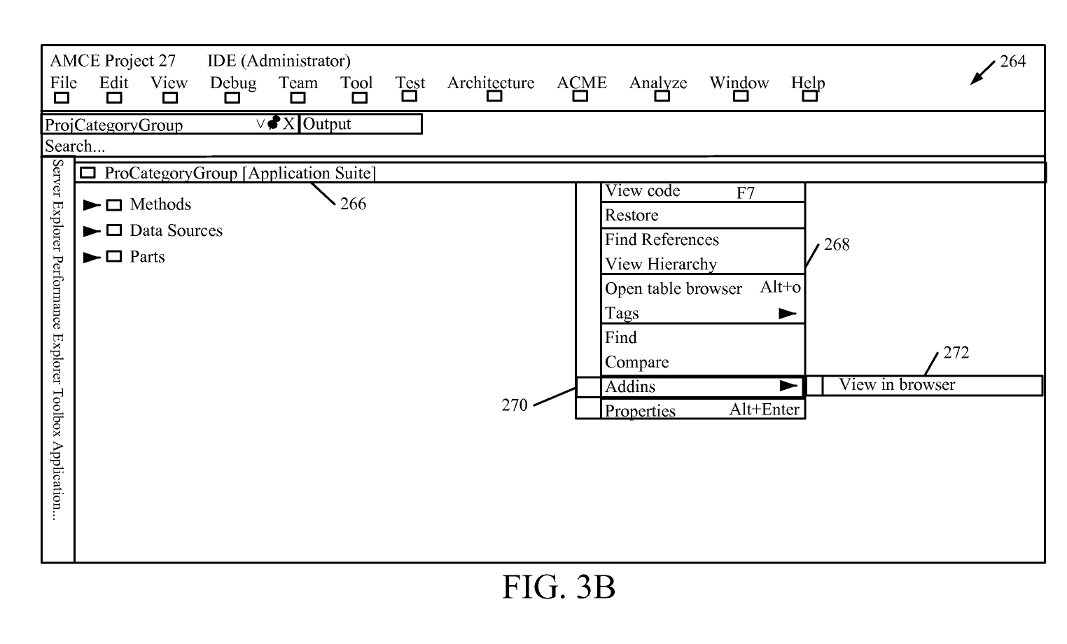

Once the add-in has been authored or generated by developer 110 and deployed in design time functionality 138, it can then be used by developer 110 (or a different developer) to perform development tasks. FIG. 3 is a flow diagram illustrating one embodiment of this. Design time functionality 138 first receives inputs from developer 110 indicating that developer 110 wishes to access IDE 102 to perform development tasks. This is indicated by block 240 in FIG. 3. This can be done by developer 110 providing inputs through a main menu 242, by accessing a project in a designer as indicated by block 244. Further, if developer 110 is already performing development operations, and is viewing a metadata structure (such as structure 190 shown in FIG. 1A), developer 110 may simply select a node in the metadata structure that the developer wishes to modify. This is indicated by block 246. Developer 110 can access IDE 102 to perform development tasks in other was as well, and this is indicated by block 248.

IDE 102 then receives inputs from developer 110 in which developer 110 seeks to discover designer elements or add-in designer elements, given the developer's current development context. This is indicated by block 250 in FIG. 3.

Design time functionality 138 then displays related designer elements and add-in designer elements that can be selected by developer 110, for use in performing his or her development tasks. This is indicated by block 252.

FIG. 3A shows one example of a user interface display 254 that illustrates this. FIG. 3A shows, for instance, that developer 110 has provided a user actuation of user input mechanism 256. Mechanism 256 illustratively corresponds to the business system 104 being developed or modified by developer 110. In response, IDE 102 generates a drop down menu 258 that can be used by developer 110 to perform a variety of different actions.

As shown in FIG. 3A, one of the user input mechanisms in menu 258 is an add-ins mechanism 260. The user can actuate mechanism 260 in order to view add-ins that are relevant to the current development context of developer 110, in IDE 102. FIG. 3A shows that, once the user does this, IDE 102 displays an add-ins menu 262 that has a plurality of user input mechanisms that can be actuated to invoke one of the listed add-ins. In the embodiment shown in FIG. 3A, the add-ins include an ACME build quality add-in, an ACME US portal add-in, and a Create Project From Change Set . . . add-in. Of course, these are only examples and different or additional add-ins can be used as well. The add-ins that were created and provided with context information indicating that they are relative to the main menu context for the ACME portion of IDE are illustratively shown in add-in menu 262.

FIG. 3B is one example of another user interface display 264. User interface display 264 is illustratively generated by IDE 102 when developer 110 is in a designer context within IDE 102. It can be seen that the user has actuated (such as by right clicking) a displayed item 266. This results in drop down menu 268 which, again, has a plurality of different user input mechanisms that can be actuated by developer 110 to perform a variety of different development tasks. One of the mechanisms includes add-ins mechanism 270. When the user actuates mechanism 270, IDE 102 displays the add-ins relevant to the current context (e.g., the designer context) of developer 110 in IDE 102. It can be seen that one add-in has been found as being relevant to the current context. It is represented by the “View In Browser” user input mechanism 272. Developer 110 can actuate mechanism 272 to view the selected content in a browser.

Referring again to FIG. 3, at some point IDE 102 may receive a developer's selection selecting one of the displayed add-ins. This is indicated by block 274 in FIG. 3.

When this happens, add-in factory 156 illustratively generates an instance of the selected add-in. This is indicated by block 276 in FIG. 3. The instance of the add-in can then receive developer inputs utilizing the add-in functionality that developer 110 ascribed to the add-in, when he or she created the add-in. This is indicated by block 278 in FIG. 3.

The add-in instance is illustratively configured to use the metadata API 170 to modify metadata (e.g., the metadata that is being developed) according to the functionality designed into the add-in. Thus, when the user provides inputs manipulating the add-in, the add-in accesses the metadata API to modify the metadata, based on those inputs. This is indicated by block 280.

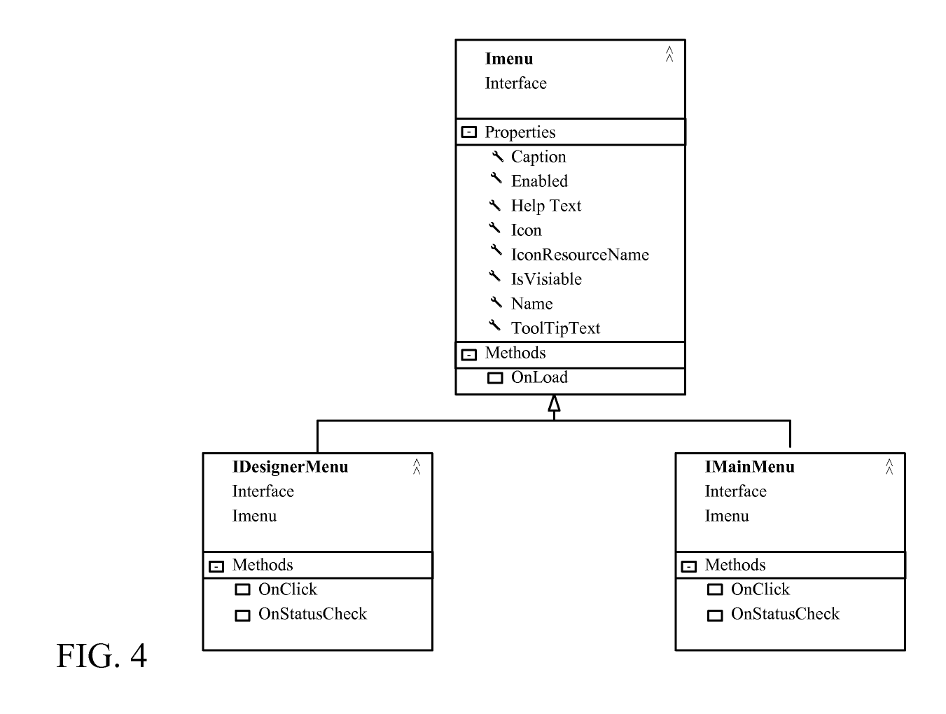

FIGS. 4-7 show a plurality of different class diagrams that are used to describe one embodiment of portions of design time extension framework 136 and portions of design time functionality 138. FIG. 4, for instance, is a class diagram showing how the designer menu interface and main menu interface are related to the menu interface.

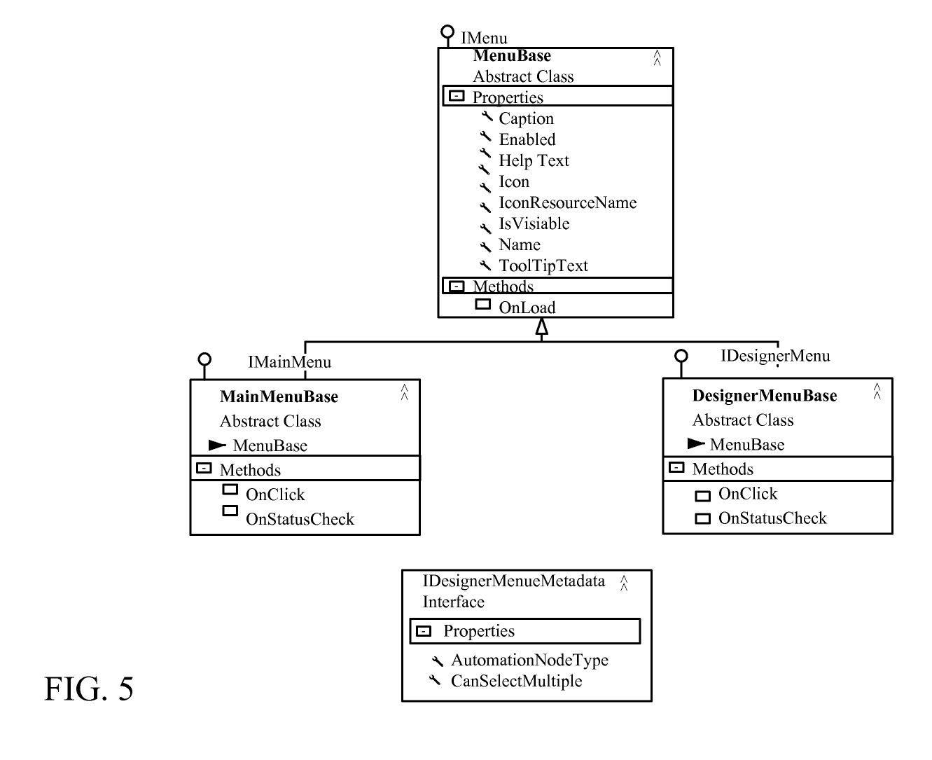

FIG. 5 shows that the main menu base class and the designer menu base class both expose an interface. The main menu base class exposes the main menu interface while the designer menu base class exposes the designer menu interface. Both derive from the menu base class which, itself, exposes the menu interface. FIG. 5 also shows one embodiment of a designer menu metadata interface.

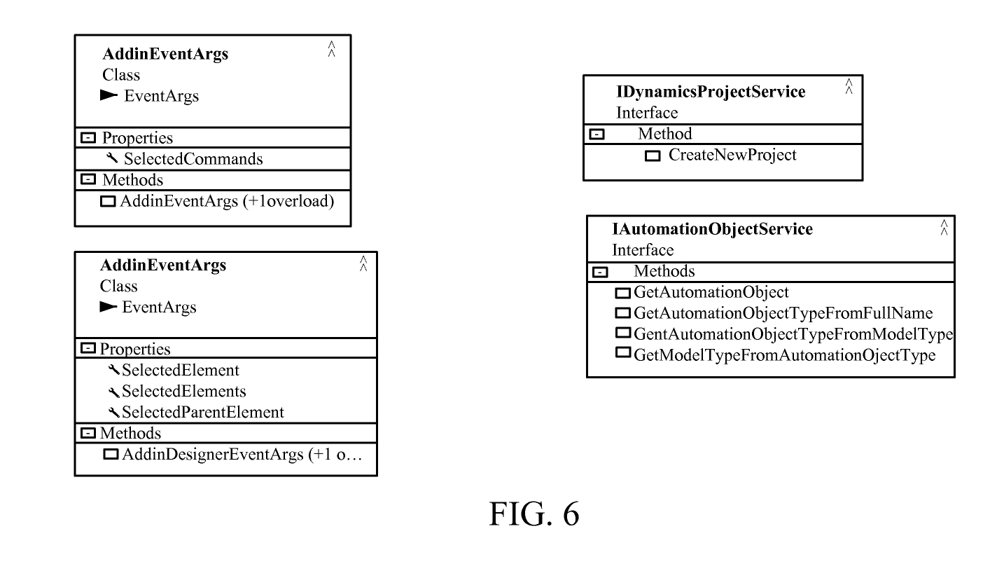

FIG. 6 shows one embodiment of an addinEventArgs class and an addinDesignerEventArgs class. These two classes can be used to obtain events and arguments for the add-ins, that facilitate communication between the rest of the design time functionality 138 of IDE 102 and the particular add-in. It illustratively facilitates the creation and manipulation of new projects within IDE 102.

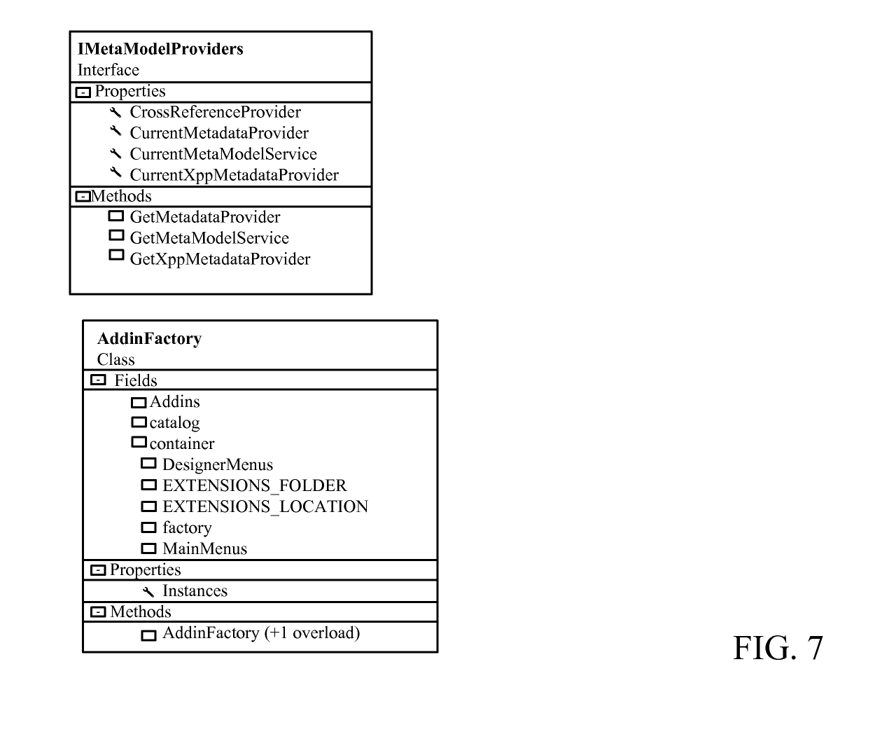

FIG. 6 also shows the AutomationObjectService interface. It is the automation API which allows the automation object to make changes to designer elements, or to create add-in designer elements in IDE 138. FIG. 7 shows one embodiment of a metamodel provider interface and a class diagram for add-in factory 156.

It will be understood that the class diagrams shown in FIGS. 4-7 are only examples. The items illustrated can be described in a wide variety of other ways as well.

It can thus be seen that the present description provides a framework that allows a developer to advantageously generate new tools as add-ins to a development environment. It describes the use of add-in project templates, automatic deployment and discovery of add-ins, a metadata API and a designer automation API. These advantageously allow the designer to quickly develop and deploy add-ins to implement new design tools. They also allow the developer to perform attribute based discovery of the add-ins. Add-in action menus are automatically created on the fly, based on how relevant a given add-in is to the designer context. This enables the system to quickly surface relevant add-ins for use in the development environment. The templates enhance both the design experience and the performance of the development environment. Because the templates are surfaced, the processing and memory overhead used by the system can be reduced because the developer is not developing the add-ins from scratch. The framework is also independent of the particular development environment in which it is deployed. This enhances flexibility of the framework.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

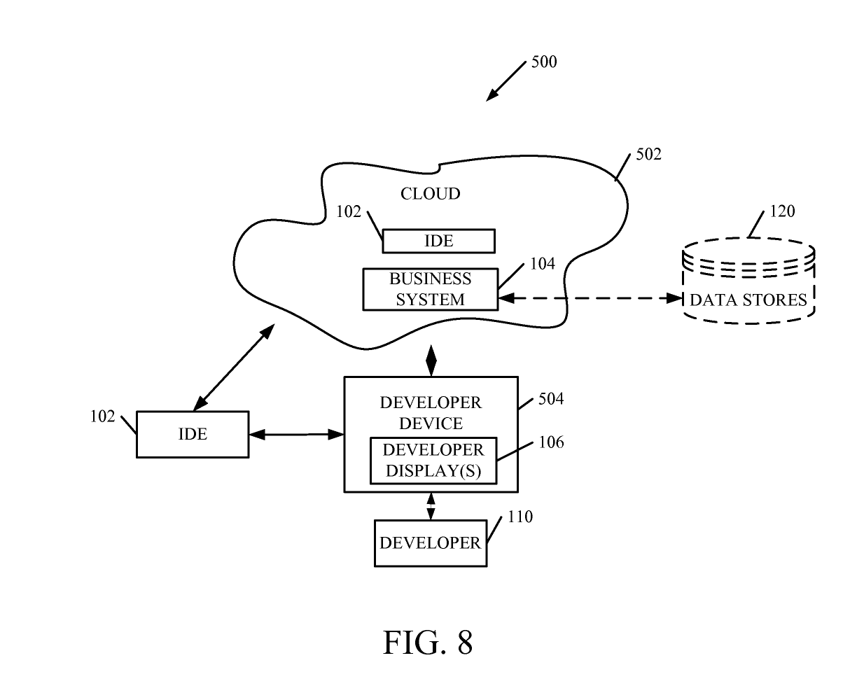

FIG. 8 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 8, some items are similar to those shown in FIG. 1 and they are similarly numbered. FIG. 8 specifically shows that IDE 102 and business system 104 as well as modified business system 112 can all be located in cloud 502 (which can be public, private, or a combination where portions are public while others are private). Therefore, developer 110 uses a developer device 504 to access those systems through cloud 502.

FIG. 8 also depicts another embodiment of a cloud architecture. FIG. 8 shows that it is also contemplated that some elements of architecture 100 can be disposed in cloud 502 while others are not. By way of example, data stores can be disposed outside of cloud 502, and accessed through cloud 502. In another embodiment, IDE 102 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

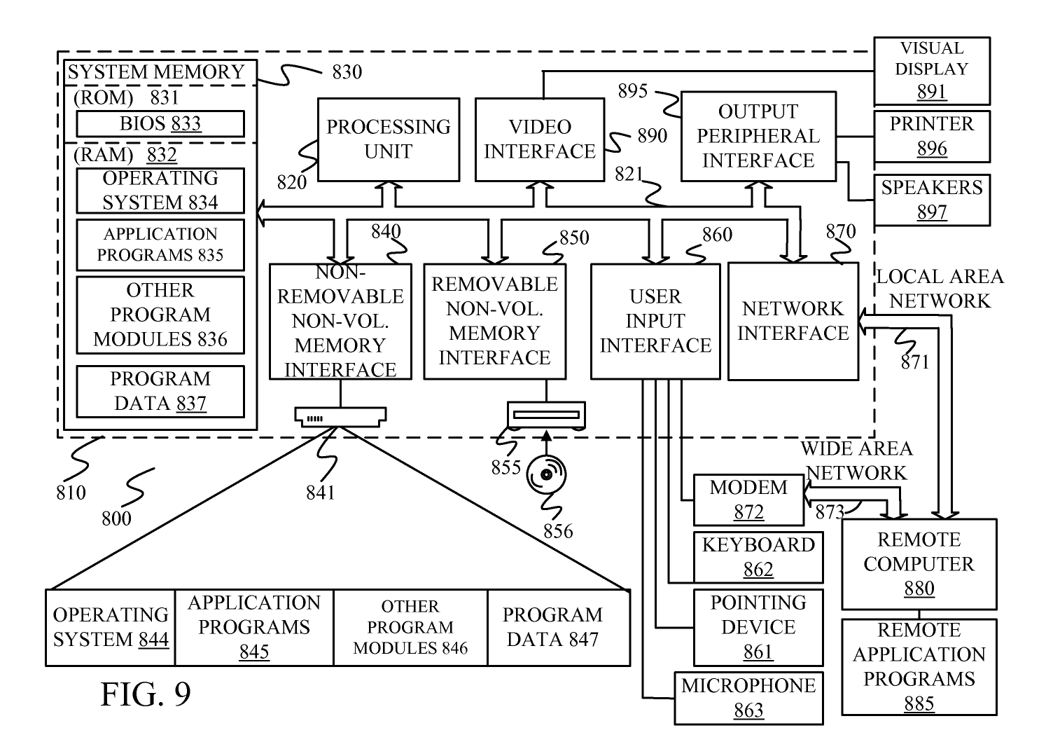

FIG. 9 is one embodiment of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an add-in generation component, in a development system, configured to generate an add-in creation user interface with creation user input mechanisms that are actuated to generate add-in functionality for an add-in designer element; and

an add-in deployment component configured to deploy the add-in designer element in the development system.

Example 2 is the computing system of any or all previous examples wherein the add-in deployment component is configured to expose an automation application programming interface invoked by the add-in generation component to generate the add-in designer element in the development system.

Example 3 is the computing system of any or all previous examples wherein the automation application programming interface is configured to be invoked by the add-in generation component to modify an existing designer element in the development system to generate the add-in designer element.

Example 4 is the computing system of any or all previous examples wherein the add-in deployment component is configured to expose a metadata application programming interface that is invoked by the add-in designer element to modify metadata defining objects under development.

Example 5 is the computing system of any or all previous examples wherein the add-in generation component is configured to access an add-in template and to generate the add-in creation user interface based on the add-in template.

Example 6 is the computing system of any or all previous examples wherein the add-in generation component is configured to generate a template selection user input mechanism that is actuated to select the add-in template from a plurality of different add-in templates.

Example 7 is the computing system of any or all previous examples and further comprising:

an add-in discovery component configured to identify a context in the development system being accessed by a user and, in response, generate an add-in selection user interface display with an add-in selection user input mechanism that is actuated to select the add-in designer element.

Example 8 is the computing system of any or all previous examples and further comprising:

an add-in factory that generates an instance of the add-in designer element for user interaction in response to actuation of the add-in selection user input mechanism.

Example 9 is a computing system in a developer environment, comprising:

a metadata visualization component configured to generate a visualization of metadata for a system under development, based on a context of the developer system being accessed by a user;

an add-in discovery component configured to identify the context in the developer environment that is being accessed and to generate an add-in user interface display, based on the context, with an add-in selection user input mechanism that is actuated to select an add-in designer element in the developer environment; and

an add-in factory configured to generate an instance of the selected add-in designer element in the developer environment, the instance having properties that define functionality for modifying the metadata.

Example 10 is the computing system of any or all previous examples wherein the selected add-in designer element instance is configured to invoke a metadata application programming interface to modify the metadata based on the functionality defined in the selected add-in designer element instance.

Example 11 is the computing system of any or all previous examples wherein the metadata visualization component is configured to generate a visualization of metadata for a business system under development, the metadata defining objects in the business system.

Example 12 is the computing system of any or all previous examples wherein the add-in discovery component is configured to generate the add-in user interface display by identifying add-in designer elements relevant to the context and to generate context menus for the relevant add-in designer elements.

Example 13 is a method, comprising:

displaying an add-in creation user interface, in a development system, with creation user input mechanisms;

receiving actuation of a creation user input mechanism;

in response to the received actuation, generating add-in functionality for an add-in designer element; and

deploying the add-in designer element in the development system.

Example 14 is the method of any or all previous examples and further comprising:

exposing an automation application programming interface; and

invoking the automation application programming interface to generate the add-in functionality of the add-in designer element in the development system.

Example 15 is the method of any or all previous examples wherein generating add-in functionality comprises:

modifying an existing designer element in the development system to generate the add-in functionality to obtain the add-in designer element.

Example 16 is the method of any or all previous examples wherein deploying the add-in designer element comprises:

exposing a metadata application programming interface; and

invoking the metadata application programming interface to modify metadata defining objects under development, in the development system.

Example 17 is the method of any or all previous examples wherein displaying an add-in creation user interface display comprises:

accessing an add-in template; and

generating the add-in creation user interface based on the add-in template.

Example 18 is the method of any or all previous examples wherein accessing the add-in template comprises:

generating a template selection user input mechanism; and

receiving actuation of the template selection user input mechanism to select the add-in template from a plurality of different add-in templates.

Example 19 is the method of any or all previous examples and further comprising:

identifying a context in the development system being accessed by a user; and

generating an add-in selection user interface display with an add-in selection user input mechanism that is actuated to select the add-in designer element, based on the identified context.

Example 20 is the method of any or all previous examples further comprising:

receiving actuation of the add-in selection user input mechanism; and

instantiating an instance of the add-in designer element for user interaction in response to actuation of the add-in selection user input mechanism.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an add-in generation component, in a development system, configured to generate an add-in creation user interface with creation user input mechanisms that are actuated to generate add-in functionality for an add-in designer element; and
an add-in deployment component configured to deploy the add-in designer element in the development system.

2. The computing system of claim 1 wherein the add-in deployment component is configured to expose an automation application programming interface invoked by the add-in generation component to generate the add-in designer element in the development system.

3. The computing system of claim 2 wherein the automation application programming interface is configured to be invoked by the add-in generation component to modify an existing designer element in the development system to generate the add-in designer element.

4. The computing system of claim 2 wherein the add-in deployment component is configured to expose a metadata application programming interface that is invoked by the add-in designer element to modify metadata defining objects under development.

5. The computing system of claim 4 wherein the add-in generation component is configured to access an add-in template and to generate the add-in creation user interface based on the add-in template.

6. The computing system of claim 5 wherein the add-in generation component is configured to generate a template selection user input mechanism that is actuated to select the add-in template from a plurality of different add-in templates.

7. The computing system of claim 5 and further comprising:
an add-in discovery component configured to identify a context in the development system being accessed by a user and, in response, generate an add-in selection user interface display with an add-in selection user input mechanism that is actuated to select the add-in designer element.

8. The computing system of claim 7 and further comprising:
an add-in factory that generates an instance of the add-in designer element for user interaction in response to actuation of the add-in selection user input mechanism.

9. A computing system in a developer environment, comprising:
a metadata visualization component configured to generate a visualization of metadata for a system under development, based on a context of the developer system being accessed by a user;
an add-in discovery component configured to identify the context in the developer environment that is being accessed and to generate an add-in user interface display, based on the context, with an add-in selection user input mechanism that is actuated to select an add-in designer element in the developer environment; and
an add-in factory configured to generate an instance of the selected add-in designer element in the developer environment, the instance having properties that define functionality for modifying the metadata.

10. The computing system of claim 9 wherein the selected add-in designer element instance is configured to invoke a metadata application programming interface to modify the metadata based on the functionality defined in the selected add-in designer element instance.

11. The computing system of claim 10 wherein the metadata visualization component is configured to generate a visualization of metadata for a business system under development, the metadata defining objects in the business system.

12. The computing system of claim 11 wherein the add-in discovery component is configured to generate the add-in user interface display by identifying add-in designer elements relevant to the context and to generate context menus for the relevant add-in designer elements.

13. A method, comprising:
displaying an add-in creation user interface, in a development system, with creation user input mechanisms;
receiving actuation of a creation user input mechanism;
in response to the received actuation, generating add-in functionality for an add-in designer element; and
deploying the add-in designer element in the development system.

14. The method of claim 13 and further comprising:
exposing an automation application programming interface; and
invoking the automation application programming interface to generate the add-in functionality of the add-in designer element in the development system.

15. The method of claim 14 wherein generating add-in functionality comprises:
modifying an existing designer element in the development system to generate the add-in functionality to obtain the add-in designer element.

16. The method of claim 14 wherein deploying the add-in designer element comprises:
exposing a metadata application programming interface; and
invoking the metadata application programming interface to modify metadata defining objects under development, in the development system.

17. The method of claim 13 wherein displaying an add-in creation user interface display comprises:
accessing an add-in template; and
generating the add-in creation user interface based on the add-in template.

18. The method of claim 17 wherein accessing the add-in template comprises:
generating a template selection user input mechanism; and
receiving actuation of the template selection user input mechanism to select the add-in template from a plurality of different add-in templates.

19. The method of claim 17 and further comprising:
identifying a context in the development system being accessed by a user; and
generating an add-in selection user interface display with an add-in selection user input mechanism that is actuated to select the add-in designer element, based on the identified context.

20. The method of claim 19 further comprising:
receiving actuation of the add-in selection user input mechanism; and
instantiating an instance of the add-in designer element for user interaction in response to actuation of the add-in selection user input mechanism.
